(19) United States
(12) Patent Application Publication
(10) Pub. No.: US 2005/0149721 A1
(43) Pub. Date: Jul. 7, 2005

(54) METHOD OF SPEEDING UP PACKET FILTERING

(76) Inventor: Chih-Chung Lu, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/709,423

(22) Filed: May 5, 2004

(30) Foreign Application Priority Data
Dec. 30, 2003 (TW) 092137360

(51) Int. Cl. H04L 9/00

(52) U.S. Cl. 713/154

(57) ABSTRACT

A method of speeding up packet filtering that utilizes a search filter in compliance with the rules of the firewall, includes the following steps of presenting a mask characteristic value set in a first hash space with regard to all specific masks in need of being filtered in the firewall rules; presenting a packet characteristic value set in a second hash space with regard to each packet received by the firewall; performing a specific Boolean operation in use of the first and second hash spaces with the same size; and as long as the result of the specific Boolean operation determine that the packet characteristic value set is out of the mask characteristic value set, rapidly allowing the packet to pass through the firewall so as to reduce calculation time of all of the firewall rules, decrease system loading and prevent network congestion.

### BACKGROUND OF INVENTION

1. Field of the Invention

The present invention relates to a method of speeding up packet filtering, and more particularly, to a method of speeding up packet filtering with a search filter used in a network security apparatus.

2. Description of the Prior Art

The last development of networking technology facilitates rapid transmission of large amounts of data among different places in the world. How to improve network security becomes an important issue. In an ordinary computer networking system, several networking apparatuses connected to a backbone network, such as a virtual private network (VPN), a gateway, and a router mostly have firewalls disposed therein or the outside thereof. Such firewall that provides a mechanism of packet filtering implements protection in the IP Layers. The packet filtering principle of the mechanism is to check each out-coming packet passing through the firewall with using a firewall rule predefined by users. However, each firewall rule indicates a cost in searching, which includes time consumption, Isystem loading, and labor power. Excess firewall rules or excess details defined within the rules can result in higher accuracy in searching but higher searching costs. If it spends too much time to process packets, the performance of the whole networking will decrease or the network congestion will occur. This situation is not desirable. On the other hand, only considering the searching cost but neglecting the protection score of a firewall would result in the degradation of the performance of the firewall. Therefore, one thing to consider when designing a firewall is to filter packets accurately with the lowest possible cost.

A conventional method of packet filtering is to determine if each out-coming packet is in a score defined by the firewall rules. A commonly used one of the methods, called “linear search”, is to respectively check the received packets with each firewall rule. In addition, some improved methods apply known searching algorithms on filtering packets that are harmful or suspected. However, most packets that the firewall receives are not included in the score defined by the firewall and thus are unharmful. In other words, most packets can pass the filtering of a firewall. It means that most searching algorithms spend too much searching cost, i.e. time, in filtering packets that need not be filtered.

To overcome the disadvantages of the prior art, the present invention utilizes a search method of low cost before searching packets to find most well-behaved packets and let them pass the firewall, and leave a small amount of packets having problems checked by the conventional ways so as to lower searching cost without modifying any firewall rule.

The present invention utilizes a search filter to solve the problems described above. “Search filter” is the method of searching words or documents proposed by Severance and Lohman in 1976. The principle of the method is that: selecting a Hash function, such as MD5 first; taking a value to be searched, such as “m”, as the “key” of the Hash function, such as f(m) to perform Hush operation and obtain a proper data structure arrangement; and using the data structure to select the values to be checked. When a key is selected, it is not sure that the key can be fined in a search set according to the property of search filter, because the Hash space that the search filter uses is limited. On the other hand, when a key selected does not belong to a search set, the search filter determines that the key does not belong to the search set.

### SUMMARY OF INVENTION

According to the claim 1, the present invention discloses a method of speeding up packet filtering used in a network security apparatus comprising: generating a first hash space according to at least one rule used to filter the packets received by the network security apparatus, and the first hash space presenting a mask characteristic value set; generating a second hash space according to at least one of the packets received by the network security apparatus, and the second hash space with the same size as the first hash space, presenting a packet characteristic value set; performing a specific Boolean operation with the first hash space and the second hash space; and determining whether the packet characteristic value set is out of the mask characteristic value set, according to the results of said Boolean operation, then it is decided whether the packet is allowed to pass through the network security apparatus.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a network and firewall according to a preferred embodiment of the present invention.

FIG. 2 illustrates a flowchart of speeding up packet filtering in the present invention.

FIG. 3 illustrates a flowchart of generating a packet characteristic value set.

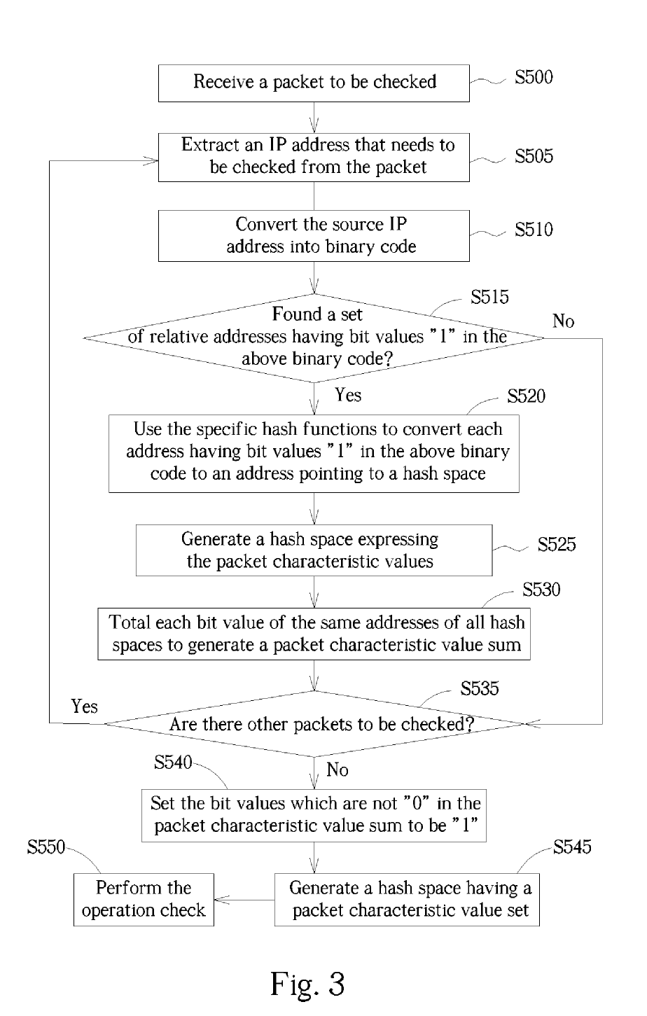

FIG. 4 illustrates a flowchart of a checking operation.

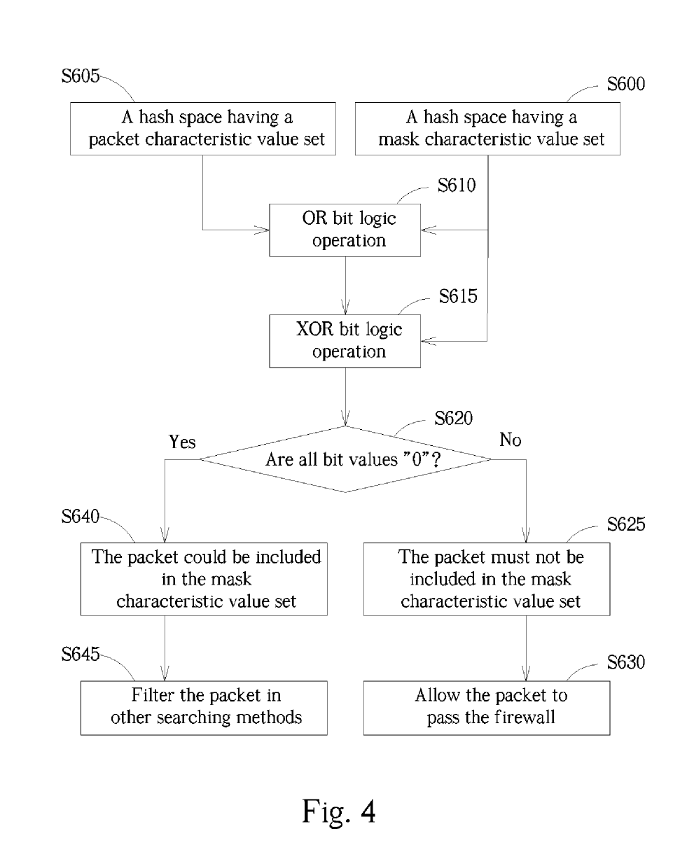

### DETAILED DESCRIPTION

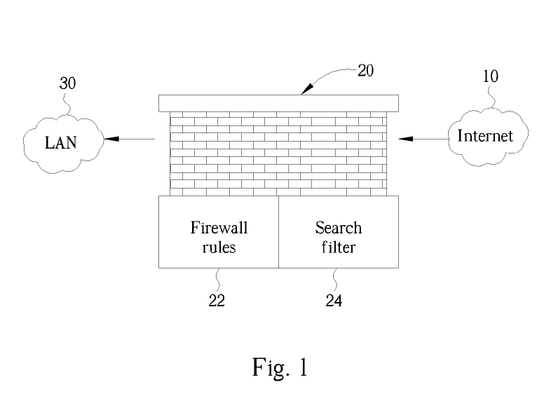

Please refer to FIG. 1. FIG. 1 illustrates a network and firewall according to a preferred embodiment of the present invention. The invention is applied to a network security device, such as the firewall 20, and performs packet filtering with a plurality of pre-installed firewall rules 22 in the firewall 20. The firewall 20 can be connected between the Internet 10 (or other wide-area network) and a local area network (LAN) 30 as shown in FIG. 1 to filter all packets from the Internet 10. The packets which are determined to be acceptable after filtering can enter the LAN 30.

According to the principles of a search filter described before, method of speeding up packet filtering in the present invention includes:

1. A method of generating a mask characteristic value set:

(1) Predetermined Conditions:

(a) Suppose the firewall 20 in the FIG. 1 has N firewall rules {1≦i≦N|rᵢ}, wherein each rule consists of five itmes: {source network rᵢnetₛ, destination network rᵢnet_{d}, source port rᵢportₛ, destination port rᵢport_{d}, protocol rᵢp}. Each network in the above rules includes the IP addresses that users want to remove.

(b) Predetermine K independent hash functions hi {1≦i≦K}, (for example, two independent hash functions h1 and h2 do not make ensure that if m≠m′, h1(m)‡h2(m′)) for generating a hash function space H.

(c) Notice that the method of the present invention is limited to the size of the predetermined hash space and the characteristics of the selected hash function. In addition, functions of the search filter mentioned above can be achieved by hardware or software.

(2) Method Flow:

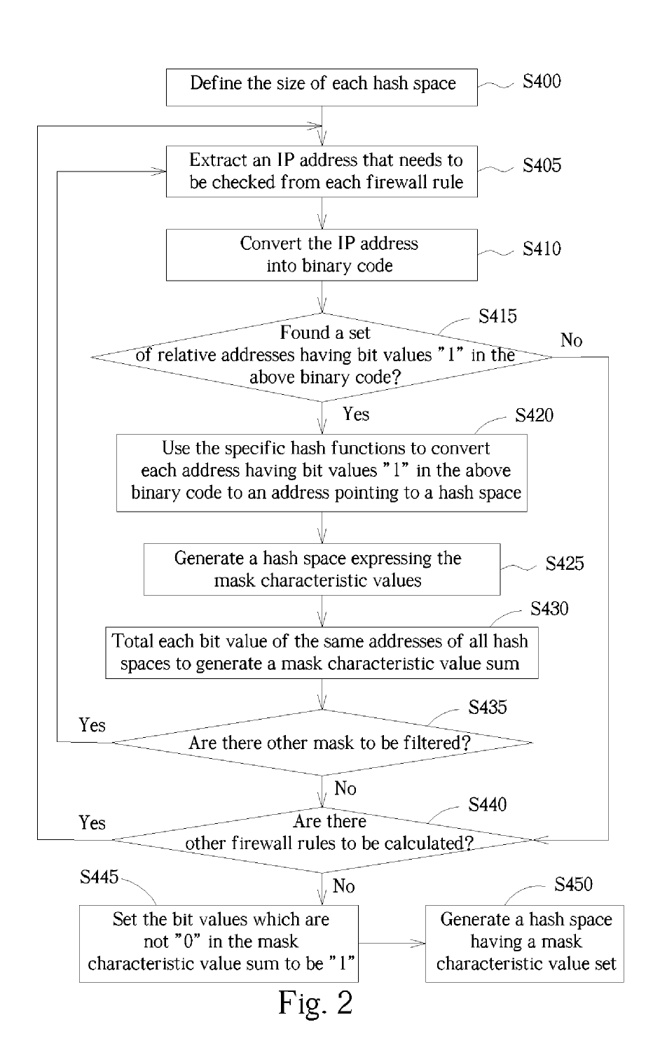

As the procedure S400 illustrates in FIG. 2, first define the volume of each hash space as the volume of output address space of each hash function hᵢ=C*K*L, wherein C is a self-defined constant, and L is the number of bits in the IP addresses (take IPV4 for example, L=32).

As the procedure S405 shows, the method extracts a source network rᵢnetₛ from each firewall rule. In the procedure S410, the method converts the source network rᵢnetₛ into the binary code (including bit values and addresses). In the procedure S415, the method searches for a set of M relative addresses bₘ (0≦bₘ≦L−1, 0≦m≦M−1) which have bit values “1” from the codes of the source network rᵢnetₛ. In the procedure S420, the method sets each address having a bit value “1”, source port rᵢportₛ and protocol rᵢp, to be the keys of the hash function and substitutes the keys into K specific hash functions hᵢ (such as hᵢ (bₘ, rᵢportₛ, rᵢp)) for hash calculation in order to get K*M values kⱼ between 0 to (C*K*L)−1. These kⱼ are the relative addresses pointing to a hash space Hₛ in the source network. As the described in the procedure S425, the set of the relative addresses pointing to a hash space Hₛ can express the characteristic values of the source network rᵢnetₛ in the hash space Hₛ. However, the keys of the hash function mentioned before are chosen by the user, but they should be at least one of the address having a bit value “1”, source port rᵢportₛ and protocol rᵢp. For example, the key of the hash function is the address having a bit value “1” in the network.

Like the filtering procedure of the source network rᵢnetₛ described before, the filtering procedures of the destination network rᵢnet_{d} for the same firewall rule rᵢ are to repeat the procedures S400 to S250: by first converting the destination network rᵢnet_{d} into the binary code (including bit values and address), then setting W addresses b_{w} (0≦b_{w}≦L−1, 0≦w≦w−1) having bit value “1”, destination port rᵢport_{d} and protocol rᵢp as the keys of the hash function, and substituting the keys into K specific hash functions hᵢ (such as hᵢ (b_{w}, rᵢport_{d}, rᵢp)) for hash calculation in order to get K*M values k between 0 to (C*K*L)−1. These kⱼ include the relative addresses pointing to a hash space H_{d} in the destination network rᵢnet_{d}. The set of the relative addresses pointing to a hash space H_{d} can express the characteristic value of the source network rᵢnetₛ in the hash space H_{d}. Notice that each hash space uses the same C, K and L, so the size of the hash space H_{d} mentioned above equals the size of the hash space Hₛ, and also equals sizes of other hash spaces.

In the procedure S435 and the procedure S440, the method repeats the same calculations for networks of N firewall rules (include source network and destination network) and obtain a plurality of hash spaces H_{d} and Hₛ. In d the procedure S430, the method collects the sets of the relative addresses of all masks pointing to the hash space H in the N firewall rules. For example, the method totals each bit value of the same addresses of all hash spaces H_{d} and Hₛ in N firewall rules so that the characteristic value sum of the masks in N firewall rules is presented in the same hash space H (H=H_{d}+Hₛ).

In the procedure S445, the method sets the bit values which are out of the value “0” in the hash space H of the characteristic value sum to be “1”. Otherwise, the method keeps the bit values “0” as “0”. Finally in the procedure S450, the method obtains a mask characteristic value set of N firewall rules in the same hash space H.

2. A method of generating a packet characteristic value set:

(1) Predetermined Conditions:

Suppose that each packet p to be checked includes: {source IP pipₛ, destination IP Pip_{d}, source port pportₛ, destination port pport_{d}, protocol pp}, and the method of processing packets is similar to the method of processing networks mentioned before. The present invention defines the volume of another hash space H′=the volume of previous hash space H=the volume C*K*L, and resets each bit to “0”, and uses the same K hash functions hᵢ {1≦i≦K}.

(2) Method Flow:

Firstly in the procedure S550, the method receives a packet p to be checked. In the procedure S505, the method extracts a source IP pipₛ from the packet. In the procedure S510, the method converts the source IP pipₛ of the packet into binary code. In the procedure S505, the method searches for a set of M′ relative addresses bₘ (0≦bₘ′≦L−1,01≦m≦M−1) which have bit values “1” from the code of the source IP pipₛ. In the procedure S520, the method sets each address having a bit value “1”, source port pportₛ and protocol pp, as the keys of the hash function, and substitutes the keys into K hash functions hᵢ (such as hᵢ (b″ₘ, pportₛ, pp)) for hash calculation in order to obtain K*M values k between 0 to (C*K*L)−1. These kⱼ include the relative addresses pointing to a hash space H's in the source IP pipₛ. As the described in the procedure S525, the setting of the relative addresses pointing to a hash space H's can present the characteristics of the source IP pipₛ in the hash space H′ₛ.

According to the same principles, if setting the destination IP pip_{d}, the destination port pport_{d}, and the protocol pp as the keys of the hash function to perform calculations of K hash functions, one converts destination IP pip_{d} of the packet into a set of relative addresses pointing to a hash space H′ₛ. Thus, the mask characteristic values of the destination IP pip_{d} of the packet are presented in the hash space H′_{d}.

In the procedure S535, the method repeats the same calculations for other IP addresses in one packet. In the procedure S530, the method collects the sets of the relative addresses of all IP addresses pointing to the hash space H′ₛ of the packet. For example, the method totals the bit values belonging to the same address of all hash spaces H′_{d} and H′ₛ and shows the packet characteristic value sum in a hash space H′ (H′=H′_{d}+H′ₛ). In the procedure S540, the method sets the bit values which are out of the value “0” in the hash space H′ to be “1”, 0≦j≦(K*M′)−1. Finally, in the procedure S545, the method obtains a packet characteristic value set in the hash space H′.

Then, in the procedure S550, the method performs a Boolean operation checking. For the same hash space, the method checks the packet characteristic value set by the mask characteristic value set described above to determine if the packet characteristic value set is covered in the mask characteristic value set.

3. Method of Operation Checking:

First in the procedures S600 and S605, the method obtains a hash space H having a mask characteristic value set and a hash space H having a packet characteristic value set. In the procedure S610 and S615, the method performs the following Boolean operation:

(H OR H′) XOR H

In the procedure S620, the method determines the result of the above Boolean operation. If all the bits are “0”, the method performs the procedure S640; the IP address of the packet p could be included in the mask characteristic value set of the N firewall rules. Then, as shown in the procedure S645, the method confirms the firewall rule or filters the packet in coordination with a further searching mechanism (with higher cost). Otherwise, if the results of the procedure S620 have at least one bit that is out of the value “0”, it means, as shown in the procedure S625, the IP address of the packet p must not be included in the mask characteristic value set of the N firewall rules. Then, the method performs the procedure S630, allowing the packet to pass the firewall.

Notice that if there is any other additional/reduced firewall rule, the mask characteristic value H_{c} in the hash space of the rule should be found, and then the hash function having the mask characteristic value sum is H=H−H_{c} or H=H+H_{c}, the method calculating the new mask characteristic value set. If the firewall rules need modifying, repeat the method described above and remove the old rules and add the new rules to obtain a new mask characteristic value set.

### 4. EXAMPLES

Suppose that a firewall has two firewall rules (N=2), as follows:

| | Source | Source | Destination | Destination | | |
|---|---|---|---|---|---|---|
| Sequence | Network | Port | Network | Port | Protocol | Action |
| 1 | 12.0.0.0/24 | 0 | 202.1.237.21/32 | 80 | 1 | Accept |
| 2 | 12.0.0.0/24 | 0 | 172.17.23.152/29 | 23 | 1 | Accept |

(wherein “0” in the communication port represents any port)

Additionally, suppose another constant C=2, the size of each IP address L=32, and two independent hash functions are {1≦i≦2|hᵢ} (K=2), so the size of each hash function H=the size of each output addressing space=C*K*L=2*2*32=128 bits. The method resets each bit to “0” and the hash function H becomes

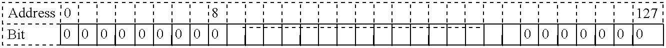

The method extracts a source network r₁netₛ (12.0.0.0/24) from the first firewall rule and converts the source network into binary code, as follows:

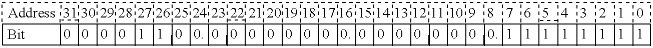

The method searches for a set of M relative addresses having bit value “1” from the binary code of the above. Therefore, we know: M=10, and the set of the relative addresses={b0, b1, b2, b3, b4, b5, b6, b7, b8, b9}={0,1,2,3,4,5,6,7,26,27}

The method sets the relative addresses mentioned above in which the binary bit values are “1”, source port r₁portₛ(0) and protocol r₁p(1), as the keys of the hash function, and substitutes the keys into two hash functions hᵢ to obtain the following 20 M×K address sets pointing to a hash function H₁ₛ:
h1(0,0,1)=41, h1(1,1,1)=111, h1(2,0,1)=41, h1(3,0,1)=39,
h1(4,0,1)=100, h1(5,0,1)=42, h1(6,0,1)=1, h1(7,0,1)=21,
h1(26,0,1)=92, h1(27,0,1)=4
h2(0,0,1)=21, h2(1,0,1)=41, h2(2,0,1)=40, h2(3,0,1)=1,
h2(4,0,1)=98, h2(5,0,1)=120, h2(6,0,1)=12, h2(7,0,1)=88,
h2(26,0,1)=76, h2(27,0,1)=110

According to the address sets pointing to a hash function H₁ₛ, the following shows the source mask characteristic value which presents the first firewall rule in the hash space H₁ₛ:

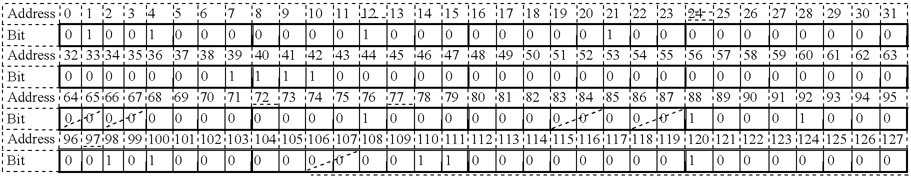

The method extracts a destination network r₁net_{d} (202.1.237.21/32) from the first firewall rule, and converts the destination network r₁net_{d} to binary code:

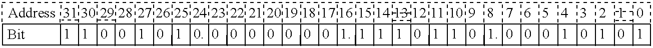

The method searches for sets of W relative addresses having bit value “1” from the binary code of the destination network r₁net_{d} described above. Therefore, W=14, the sets of W relative addresses={b0, b1, b2, b3, b4, b5, b6, b7, b8, b9, b10, b11, b12, b13}={0,2,4,8,10,11,13,14,15,16,25,27,30,31}

The method sets the relative addresses in which each bit value of the binary codes is “1” described above {0,2,4,8,10,11,13,14,15,16,25,27,30,31}, destination port r₁port_{d}(80) and protocol r₁p(1), as the keys of the hash function, and substitutes the keys into two hash functions hᵢ to obtain the following 28 (K×W) subsets of addresses that point to a hash space H_{1d}:
h1(0,80,1)=50, h1(2,80,1)=76, h1(4,80,1)=43,
h1(8,80,1)=66,
h1(10,80,1)=9, h1(11,80,1)=12, h1(13,80,1)=21, h1(14,80,1)=36,
h1(15,80,1)=61, h1(16,80,1)=58, h1(25,80,1)=81, h1(27,80,1)=108,
h1(30,80,1)=52, h1(31,80,1)=12
h2(0,80,1)=20, h2(2,80,1)=67, h2(4,80,1)=7, h2(8,80,1)=96,
h2(10,80,1)=12, h2(11,80,1)=84, h2(13,80,1)=61, h2(14,80,1)=29,
h2(15,80,1)=17, h2(16,80,1)=77, h2(25,80,1)=20, h2(27,80,1)=99,
h2(30,80,1)=121, h2(31,80,1)=41

According to 28 sets of addresses that point to a hash space H_{1d}, the destination mask characteristic value of the first firewall rule is presented in the hash space H_{1d}, and the method collects all sets of addresses in which all networks pointing to a hash space H of the first firewall rule. In other words, the method totals the bits belonging to the same address in two hash spaces H_{1d} and H₁ₛ in order to present the mask characteristic value sum of the first firewall rule in the hash space H (H=H₁ₛ+H_{1d}):

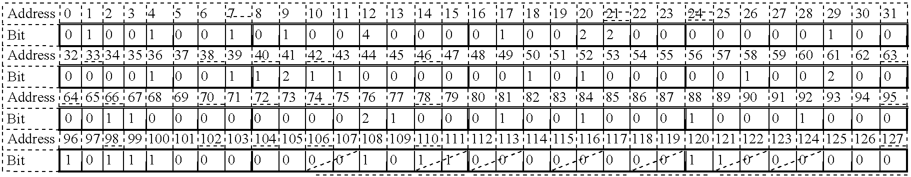

The method extracts a source network r₂netₛ (12.0.0.0/24) from the second firewall rule. However, the source network r₂netₛ is the same as source network r₁netₛ, so the operation procedure of the hash function is omitted. The hash function H_{2S} is added directly in the above hash space H to total the bits. Thus, the hash function H=H+H_{2S} presents the mask characteristic value sum, as follows:

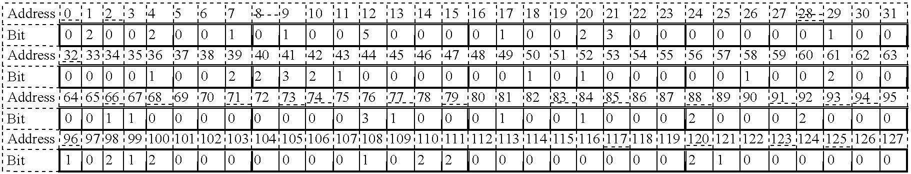

Next the method extracts a destination network r₂net_{d} (172.17.23.152/29) from the second firewall rule and converts the destination network r ₂net_{d} into the binary code, as follows:

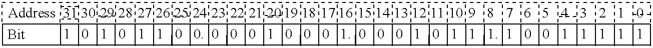

The method searches for sets of W relative addresses having bit value “1” from the binary code of the destination network r₂net_{d} described above. Therefore, W=16, the sets of W relative addresses={b0, b1, b2, b3, b4, b5, b6, b7, b8, b9, b10, b11, b12, b14, b14, b15}={0, 1,2,3,4,7,8,9,10,12,16,20,26,27,29,31}

The method sets the relative addresses in which each bit value of the binary code is “1” described above {0,2,4,8,10,11,13,14,15,16,25,27,30,31}, destination port r₂port_{d}(80) and protocol r₂p(1), as the keys of the hash function, and substitutes the keys into two hash functions hᵢ to obtain the following 32 (K×W) sets of addresses that points to a hash space H_{2d}:
h1(0,23,1)=3, h1(1,23,1)=69, h1(2,23,1)=30, h1(3,23,1)=0,
h1(4,23,1)=56, h1(7,23,1)=59, h1(8,23,1)=83, h1(9,23,1)=46,
h1(10,23,1)=31, h1(12,23,1)=47, h1(16,23,1)=61, h1(20,23,1)=79,
h1(26,23,1)=13, h1(27,23,1)=17, h1(29,23,1)=28, h1(31,23,1)=82
h2(0,23,1)=13, h2(1,23,1)=9, h2(2,23,1)=82, h2(3,23,1)=10,
h2(4,23,1)=109, h2(7,23,1)=34, h2(8,23,1)=79, h2(9,23,1)=22,
h2(10,23,1)=59, h2(12,23,1)=111, h2(16,23,1)=12, h2(20,23,1)=7,
h2(26,23,1)=109, h2(27,23,1)=107, h2(29,23,1)=3, h2(31,23,1)=55

According to the 32 sets of addresses that point to a hash space H_{2d}, the method presents the destination mask characteristic value of the second firewall rule in the hash space H_{2d}, and adds the hash space H_{2d} into the previous hash space H. Thus, the method totals the bit values belonging to the same address and presents the mask characteristic value sum of the whole firewall rules in the hash space H (H=H+H_{2d}).

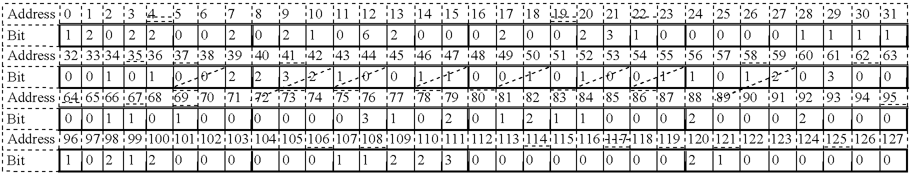

The method set the bit values which are out of the value “0” in the above mask characteristic value sum to “1” so as to present mask characteristic value sets of all firewall rules in the hash space H.

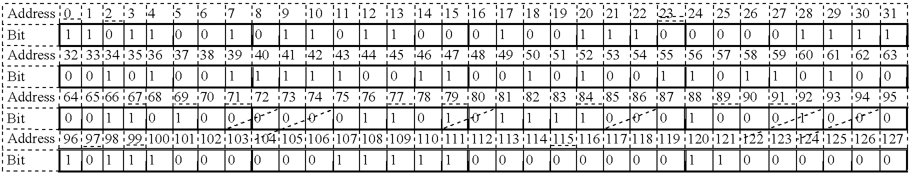

As long as the firewall receives a packet p that tries to pass the firewall (pipₛ, pportₛ, pip_{d}, pport_{d}, pp)=(12.0.0.4, 1067, 172.17.23.153, 80, 1), the method of processing the packet is similar to the method of processing the firewall rules, which utilizes two equivalent (K=2) hash functions hᵢ {1≦i≦2} to define a hash space H′=C*K*L=128 bit of the same size, and each bit value is reset to “0” as follows:

Hash Space H′

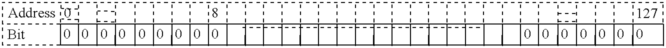

The method extracts a source IP pipₛ (12.0.0.4) from the packet and convert the source IP into the binary code, as follows:

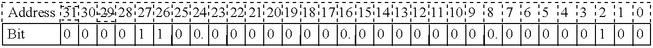

The method searches for sets of M′ relative addresses having bit values of “1” from the binary code of the source IP pipₛ described above. Therefore, M′=3, the sets of M′ relative addresses {b0, b1, b2}={2,26,27}.

Subsequently, the method sets the relative addresses in which each bit value of the binary code is “1” described above {2,26,27}, source port pportₛ (1067) and protocol pp (1), as the keys of the hash function, and substitutes the keys into two hash functions hᵢ to obtain the following 6 (K×M) sets of addresses that points to a hash space H′:
h1(2,1067,1)=61, h1(26,1067,1)=10, h1(27,1067,1)=111
h2(2,1067,1)=39, h2(26,1067,1)=46, h2(27,1067,1)=12

According to 6 sets of addresses that point to a hash space H′, the following presents the source packet characteristic value:

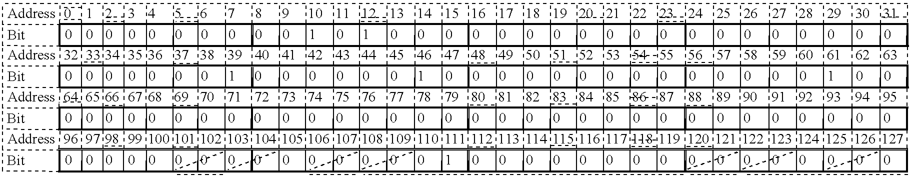

The method extracts a destination IP pip_{d} (172.17.23.153) from the same packet and converts the destination IP pip_{d} into binary code, as follows:

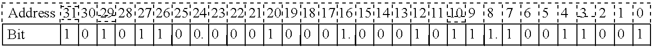

The method searches for sets of M′ relative addresses having bit values of “1” from the binary code of the destination IP pip_{d} described above. Therefore, W=14, the sets of the relative addresses={b0, b1, b2, b3, b4, b5, b6, b7, b8, b9, b10, b11, b12, b13}={0,3,4,7,8,9,10,12,16,20,26,27,29,31}.

The method sets the relative addresses in which each bit value of the binary codes is “1” described above {0,3,4,7,8,9,10,12,16,20,26,27,29,31}, destination port pport_{d} (80) and protocol pp (1), as the keys of the hash function, and substitutes the keys into two hash functions hᵢ to obtain the following 28 (K×W′) sets of addresses that point to a hash space H′_{d}:
h1(0,80,1)=60, h1(3,80,1)=1, h1(4,80,1)=107, h1(7,80,1)=8, h1(8,80,1)=39,
h1(9,80,1)=61, h1(10,80,1)=40, h1(12,80,1)=55, h1(16,80,1)=83,
h1(20,80,1)=97, h1(26,80,1)=24, h1(27,80,1)=66, h1(29,80,1)=70,
h1(31,80,1)=24
h2(0,80,1)=25, h2(3,80,1)=33, h2(4,80,1)=1, h2(7,80,1)=66, h2(8,80,1)=51,
h2(9,80,1)=43, h2(10,80,1)=37, h2(12,80,1)=13, h2(16,80,1)=90,
h2(20,80,1)=69, h2(26,80,1)=22, h2(27,80,1)=91, h2(29,80,1)=111,
h2(31,80,1)=121

According to the 28 sets of addresses that point to the hash space H′_{d}, the method presents the destination packet characteristic value in the hash space H′_{d}. Then, the method collects all sets of the addresses that point to the hash space H′ and adds the hash space H′_{d} into the previous hash space H′ₛ. For example, the method totals the bit values belonging to the same address to generate a hash space H′=H′ₛ+H′_{d}. The following presents the packet characteristic value sum.

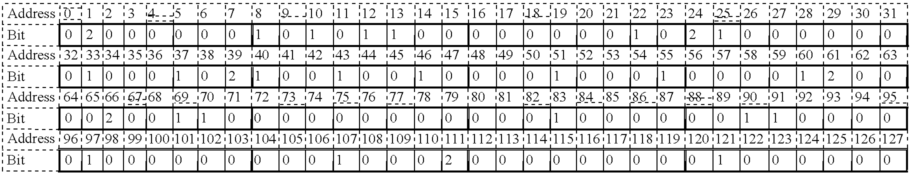

The method sets the bit values which are out of the value “0” in the above mask characteristic value sum to “1” so as to present the packet characteristic value sets in the hash space H′.

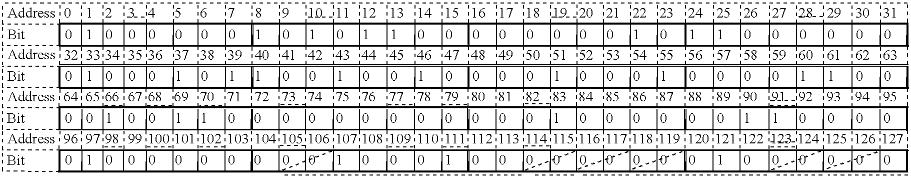

The method performs operation checking: (H OR H) XOR H. Then, we find that at least one bit value is out of the value “0”, so the packet characteristic value set is not included in the mask characteristic value set. That means the packet p does not satisfy any firewall rule previously described, and so is allowed to pass the firewall.

The method of speeding up packet filtering in the present invention utilizes a search filter to determine if one packet is covered by the range of the firewall rules in a fixed period of time and lets a large amount of packets be out of the range, considered as acceptable packets, rapidly pass the firewall so as to prevent excessive traffic in the network. On the other hand, a small amount of packets inside the range possibly having problems can be further filtered with other packet filters of higher searching cost. Therefore, the present invention can reduce the searching time and improve searching efficiency, which cannot be achieved by the prior art.

Those skilled in the art will readily observe that numerous modifications and alterations of the device may be made while retaining the teachings of the invention. Accordingly, the above disclosure should be construed as limited only by the metes and bounds of the appended claims.

1. A method of speeding up packet filtering used in a network security apparatus comprising:
generating a first hash space according to at least one rule used to filter the packets received by the network security apparatus, and the first hash space presenting a mask characteristic value set;
generating a second hash space according to at least one of the packets received by the network security apparatus, and the second hash space with the same size as the first hash space, presenting a packet characteristic value set;
performing a specific Boolean operation with the first hash space and the second hash space; and
determining whether the packet characteristic value set is out of the mask characteristic value set, according to the results of said Boolean operation, then it is decided whether the packet is allowed to pass through the network security apparatus.

2. The method of speeding up packet filtering in claim 1 wherein the network security apparatus comprises a firewall so that the rule can be pre-installed in the firewall.

3. The method of speeding up packet filtering in claim 2 wherein the firewall comprises a search filter assisting the rule of the firewall to filter the packets.

4. The method of speeding up packet filtering in claim 1 wherein the content of each rule comprises at least a specific mask that needs to be filtered.

5. The method of speeding up packet filtering in claim 4 further comprising:
converting the specific mask in each rule into binary codes;
converting each relative address with bit values “1” in the binary codes into a corresponding address pointing to the first hash space in order to obtain a set of the corresponding addresses, with regard to each said specific mask, pointing to the first hash space; and
collecting each set of the corresponding addresses pointing to the first hash space together thereby presenting a mask characteristic value set with regard to all of said specific masks in the first hash space.

6. The method of speeding up packet filtering in claim 5 further comprising:
utilizing the relative address with bit values “1” in the binary codes to be a key of at least a specific hash function, and then performing the hash operation to obtain each corresponding address pointing to the first hash space.

7. The method of speeding up packet filtering in claim 5 further comprising:
generating a first hash space, with regard to each specific mask, having a specific mask characteristic value, according to each set of the corresponding addresses pointing to the first hash space; and
totaling each bit value with the same address in each said first hash space having specific mask characteristic value thereby presenting a mask characteristic value set with regard to all of the specific masks in one first hash space.

8. The method of speeding up packet filtering in claim 1 wherein each packet comprises at least an IP address that needs to be checked.

9. The method of speeding up packet filtering in claim 8 further comprising:
converting at least one IP address in each packet into binary codes;
converting each relative address with bit value “1” in the binary codes into a corresponding address pointing to the second hash space thereby obtaining a set of corresponding addresses, with regard to each said IP address, pointing to the second hash space; and
collecting each set of the corresponding addresses pointing to the second hash space together thereby presenting a packet characteristic value set with regard to the at least one packet in the second hash space.

10. The method of speeding up packet filtering in claim 9 further comprising:
utilizing each said relative address with bit value “1” in the binary codes to be a key of at least a specific hash function, and then performing a hash operation thereby obtaining each corresponding address pointing to the second hash space.

11. The method of speeding up packet filtering in claim 9 further comprising:
generating the second hash space, with regard to each said IP address, having a specific IP address characteristic value, according to each set of the corresponding addresses pointing to the second hash space; and
totaling each bit value with same address in each said second hash space having specific IP address characteristic value thereby presenting a packet characteristic value set with regard to the at least one packet in one second hash space.

12. The method of speeding up packet filtering in claim 1 further comprising:
when at least one of bit values of the results of the Boolean operation in the first hash space and the second hash space is out of value “0”, it is ensured that the packet characteristic value set is out of the mask characteristic value set and therefore the packet can be allowed to pass through the network security apparatus.

13. A method of speeding up packet filtering used in a network security apparatus, including a method of generating a mask characteristic value set with regard to all specific masks that need to be filtered, comprising the steps of:
extracting each of the specific masks from at least one rule pre-installed in the network security apparatus;
converting each of the specific masks into binary codes;
converting each relative address with bit value “1” in the binary codes into a corresponding address pointing to a hash space thereby obtaining a set of the corresponding addresses, with respect to each specific mask, pointing to the hash space; and
collecting the each set of the corresponding addresses pointing to the hash space together thereby presenting a I mask characteristic value set with regard to all of the specific masks in the hash space.

14. The method of speeding up packet filtering in claim 13 further comprising:
utilizing each said relative address with bit value “1” in the binary codes to be a key of at least a specific hash function, and then performing a hash operation to obtain said corresponding address pointing to the hash space.

15. The method of speeding up packet filtering in claim 13 further comprising:
generating a hash space, with regard to each specific mask, having a specific mask characteristic value, according to each set of the corresponding addresses pointing to the hash space; and
totaling each bit value with the same address in each said hash space having specific mask characteristic value thereby presenting a mask characteristic value set with regard to all of the specific masks in one hash space.

16. The method of speeding up packet filtering in claim 13 further comprising:
setting the bit values of all sets of the corresponding addresses pointing to the hash space to be “1” thereby presenting a mask characteristic value set with regard to all of the specific masks in the hash space.

17. A method of speeding up packet filtering used in a network security apparatus, including a method of generating a packet characteristic value set with regard to specific IP addresses that needs to be checked, comprising:
extracting each specific IP address from at least one packet received from the network security apparatus;
converting the each specific IP address in each packet into binary codes;
converting each relative address with bit value “1” in the binary codes into a corresponding address pointing to a hash space in order to obtain a set of the corresponding addresses, with regard to each of the specific IP addresses, pointing the hash space; and
collecting all sets of the corresponding addresses pointing to the hash space together thereby presenting a packet characteristic value set with regard to the packet in the hash space.

18. The method of speeding up packet filtering in claim 17 further comprising:
utilizing each relative address with bit value “1” in the binary codes to be a key of at least a specific hash function, and then performing a hash operation to obtain the corresponding address pointing to the hash space.

19. The method of speeding up packet filtering in claim 17 further comprising:
generating a hash space, with regard to each of the specific IP address, having a specific IP address characteristic value, according to each set of the corresponding addresses pointing to the hash space; and
totaling each bit value with the same address in each said hash space having a specific IP address characteristic value thereby presenting a packet characteristic value set with regard to the at least one packet in the hash space.

20. The method of speeding up packet filtering in claim 17 further comprising:
setting the bit values of all sets of the corresponding addresses pointing to the hash space to “1” in order to present the packet characteristic value set.
